(19) United States
(12) Patent Application Publication
(10) Pub. No.: US 2023/0104213 A1
(43) Pub. Date: Apr. 6, 2023

(54) Electronic Circuit and Method of Operating an Electronic Circuit

(71) Applicant: Infineon Technologies AG, Neubiberg (DE)

(72) Inventors: Marcus Janke, München (DE); Robert Hofer, Eggersdorf bei Graz (AT)

(21) Appl. No.: 17/961,181

(22) Filed: Oct. 6, 2022

(30) Foreign Application Priority Data
Oct. 6, 2021 (DE) 102021125963.0

(51) Int. Cl. G11C 13/00

(52) U.S. Cl. CPC G11C 13/0069; G11C 13/004; G11C 13/0011; G11C 2013/0083

(57) ABSTRACT

In various embodiments. an electronic circuit is provided. The electronic circuit may include at least one memory cell and a control circuit configured to determine a formation state of the at least one memory cell and set a predefined function to a predefined state of executability (e.g., enabled or disabled) based on the determined formation states. For example, the predefined function may be set to the predefined state of executability only if the determined formation states of two or more memory cells match a predefined formation state pattern, or only if a minimum number or fraction of two or memory cells are in a predefined formation state. The formation state is either unformed or formed, wherein the unformed state is an electrically isolated state, and the formed state is a state into which an initially unformed memory cell is transformable and in which the formed memory cell is repeatedly switchable between a state of low electrical resistivity and a state of high electrical resistivity.

### TECHNICAL FIELD

Various embodiments relate generally to an electronic circuit and to a method of operating an electronic circuit.

### BACKGROUND

In an electronic circuit, it may be necessary useful to permanently deactivate or activate a function.

As one example, saw-bows are currently used for transferring a chip from a fabrication/test mode, when the chip is still integrated in the wafer, to a field mode for regular use, in which the chip is simulated. The saw-bow is a circuit portion that is at least partially arranged in the saw line and automatically cut during a singulating process, whereby the fabrication/test mode is permanently deactivated.

However, saw-bows require extra effort in design and mask generation. Therefore, a more efficient way to provide a permanent deactivation (or activation) of a function in a circuit may be required.

### SUMMARY

In various embodiments, an electronic circuit is provided. The electronic circuit may include one or more memory cells and a control circuit configured to determine a formation state of each of at least one of the one or more memory cells and set a predefined function to a predefined state of executability (e.g., enabled or disabled) based on the determined formation state(s). For example, the control circuit may be configured to set the predefined function to the predefined state of executability based on the determined formation for a single memory cell, or only if the determined formation states for two or more memory cells match a predefined formation state pattern, or only if a minimum number or fraction of two or more memory cells have a predefined formation state. The formation state for each of the at least one of the one or more memory cells is either unformed or formed, wherein the unformed state is an electrically isolated state and the formed state is a state into which an initially unformed memory cell is transformable and in which the formed memory cell is repeatedly switchable between a state of low electrical resistivity and a state of high electrical resistivity.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the invention. In the following description, various embodiments of the invention are described with reference to the following drawings, in which:

FIG. 1 schematically illustrates an electronic circuit in accordance with various embodiments;

FIG. 2A and 2B schematically illustrate two different states of an electronic circuit in accordance with various embodiments;

FIG. 3A and 3B schematically illustrate two different states of an electronic circuit in accordance with various embodiments;

FIG. 4A and 4B schematically illustrate two different. states of an electronic circuit in accordance with various embodiments; and

FIG. 5 shows a process flow of a method of operating an electronic circuit in accordance with various embodiments.

### DESCRIPTION

The following detailed description refers to the accompanying drawings that show, by way of illustration, specific details and embodiments in which the invention may be practiced.

The word “exemplary” is used herein to mean “serving as an example, instance, or illustration”. Any embodiment or design described herein as “exemplary” is not necessarily to be construed as preferred or advantageous over other embodiments or designs.

Various aspects of the disclosure are provided for devices, and various aspects of the disclosure are provided for methods. It will be understood that basic properties of the devices also hold for the methods and vice versa. Therefore, for sake of brevity, duplicate description of such properties may have been omitted.

In the following, the term “memory cell” is used in the description of various embodiments. The term is used to describe a non-volatile memory cell that is individually formable and has a correspondence to the unformed/formed states of the exemplary resistive random-access memory cell (RRAM cell), i.e. an unformed state that may be single-valued and may require a forming process for reaching a programmable state, wherein, by the forming process, the memory cell may be transformed to have a multi-valued, programmable state. Examples of such a memory cell include an RRAM cell, certain types of CBRAM cells, and possibly other types of (non-volatile) memory cells. In the exemplary RRAM cell and other types of presently known memory cells that use a forming process as described above, the unformed state is a high resistance (or non-conducting) state, whereas both switchable formed states have a comparatively low resistance/high. conductivity. In principle, a memory cell having an unformed low resistance state and two switchable high resistance states may alternatively be used in various embodiments.

In various embodiments, a permanent deactivation (or activation) of a function of an electronic circuit (circuit, for short) may be provided by a memory cell, which may be evaluated before enabling the function, for example by a control circuit that pray be part of the electronic circuit

The memory cell may be suitable for serving as a permanent switch because of its particularities regarding fabrication and use: after a production of the memory cell (also referred to as an initial state of the memory cell), and before a so-called forming process, the memory cells may all be in an isolated state, i.e., a state in which the memory cells are not yet programmable. A cell current for a memory cell in the isolated s(ate, as it may be read by a read unit, for example, may return a cell current value of 0 or of essentially 0.

In the forming process, which may bring the memory cell from an unformed initial state to a formed state, a conductive path may be generated in a resistive layer. The forming may typically include or consist of applying a relatively high voltage to memory cell electrodes (e.g., 2.5V-3.5V), until an isolation layer breaks (by the relatively high voltage, vacancy or metal defect migration may be caused, which may form a filament or a conduction path) and a current flows between the electrodes.

After the conductive path is formed, the memory cell may be switchable between a relatively high resistive state (caused by an at least partial breaking of the conductive path, resulting in a relatively high resistance) and a relatively low resistive state (caused by re-forming of the conductive path, resulting in a low resistance) by applying lower voltages (e.g., 1.5V-2.0V) of correct polarity. In other words, the memory cell is in a programmable state, in which the memory cell is configured to provide two different settable states. These two states are typically referred to as “RESET state” and “SET state.”

The electrical resistance in the RESET state may be almost as high as for the unformed. cell, and it may be difficult to differentiate the two states by a reading process. However, an attempted writing (e.g., to the SET state, which would be easy to identify in a subsequent reading process) will succeed only in the case of the formed cell.

The forming process is a one-way process. In other words, once a memory cell is formed, it may be un-formed.

In various embodiments, the saw-bow (or fuse or other types of one-way switch for activating or deactivating a function) may be replaced by at least one unformed memory cell.

In the exemplary embodiment of replacing the saw-bow, the cut state would be represented by a memory cell that is formed (and optionally written). The uncut state would be represented by the unformed memory cell. Before granting access to certain functions (software, settings, hardware portions, or the like) that should, for example, only be available in a specific mode, for example a test mode, a state of the memory cell may be evaluated. While the memory cell is in the unformed state, the functions may be available. In other words, the functions may be tightly linked, e.g., hardcoded, to be executed only when the memory cell is in the unformed state. Before the shipping to the client, he memory cell may be formed, thereby permanently deactivating access to the functions, e.g., the test, functions.

In various embodiments, it may, on the other hand, be important, to ensure that a. function cannot be de-activated (after a certain point), for example a password request or other kinds of security related functions. For example, such a password request may be a nuisance during testing, and may therefore be kept de-activated in the testing phase (by keeping the memory cell in the unformed state). Later, e.g., before shipping or, for example, after some kind of personalization, the password request play be permanently enforced by forming (and optionally setting) the memory cell. The password request may be tightly linked, e.g., hardcoded, to be executed whenever the memory cell is in the formed state.

To phrase it more generally, in various embodiments, a predefined function is only activated/enabled/set to an executable state if the forming state of a memory cell has a predefined state or the forming states of one or more memory cells match a predefined pattern, or if a minimum number or fraction of one or more memory cells are in a predefined state. In the case of a single cell, the predefined pattern is either formed or unformed, the corresponding minimum number is one for the predefined state, and the corresponding fraction 100%. In those embodiments, as long as the memory cell(s) do(es) not match the predefined pattern or provide a minimum number or fraction of the cells in the predefined state, the predefined function remains or is set to the deactivated/disabled/non-executable state.

In various embodiments that are symmetric to the above-described embodiments, a predefined function is only deactivated/disabled/set to a non-executable state if the forming state of the memory cell or forming states of multiple memory cells match a predefined pattern, or if a minimum number or fraction of the memory cells are in a predefined state. In those embodiments, as long as the memory cell(s) do(es) not match the predefined pattern or provide a minimum number or traction of the cells in the predefined state, the predefined function remains or is set to the activated/enabled/executable state.

As suggested above, instead of using a single cell, a plurality of memory cells may be used.

In various embodiments, the plurality of memory cells may be used for coding a specific pattern that may need to be matched for successfully permanently activating a function (wherein a deliberate mismatch may be used for permanently deactivating the function).

This may for example be used to increase a level of security: While the above described single cell may allow anyone with access to the forming function to form the memory cell, and to thereby—depending on the application—permanently activate or deactivate one or more predefined function(s), the providing of the plurality of memory cells that have to match a predefined multi-cell-pattern may require the knowledge of the pattern to successfully permanently activate or deactivate the predefined function(s). In a case where the plurality of cells are neither in the unformed state nor have the predefined pattern, which may be indicative of a malicious attack, the circuit may he configured to indicate a fault state.

The predefined pattern may for example be used for creating a temporarily available function, for example by requiring one or more specific memory cells to be in the formed state and one or more specific memory cells to be in the unformed state to activate the function. Thus, after fabrication, when the memory cells are still in the unformed state, the function may be deactivated. For activating, the specific memory cells that are required for latching the pattern may be set to the formed state. Then the function may be available. It may be deactivated again by setting one or more of the rem g unformed memory cells to the formed state.

In various embodiments, the plurality of memory cells may be used, and only their relative fractions of formed and unformed cells may be evaluated, rather than the pattern that is formed. This type of evaluation may be useful, for example, in a case where various access levels are permanently granted. or denied.

As an example, access to a certain circuit portion, e.g., a memory portion, may be guarded by two memory cells. With 0% of the memory cells in the formed state, the memory portion may he accessible for reading and writing. With 50% of the memory cells in the formed state n other words, one of the two cells in the formed state, while the other is still unformed), write access may be denied, but read access granted. With 100% in the formed state, both the read access and the write access may be denied.

In various embodiments, the forming may transfer the memory cell to a state of low electrical resistance, which may or may not be in a resistance range typically occupied by memory cells in the SET state (in other words, after a writing to the SET state was performed), which may typically be considerably lower than the electrical resistance in the RESET state.

A memory cell used as described in the embodiments above that is found to be formed, but in the RESET state, in other words formed and with a high electrical resistance, close to the unformed state, may be considered suspicious. In other words, it may have been tampered with in an attempt to simulate the unformed state. Thus, a formed memory cell found to be in the RESET state may be configured to trigger an alarm.

The forming may in various embodiments be performed on single memory cells with on-board mechanisms.

In various embodiments, at least one memory cell may be used as a “fuse” for permanently activating or deactivating at least one pre-defined function in an electronic circuit. This may be particularly useful in a case where the circuit includes memory cells for other purposes, e.g., as a memory, anyhow.

The pre-defined functions may, for example, include storage of life-cycle states, of IDs, of keys, access-rights, locking information for features, memories, debug-interfaces, field-usage-states, etc.

For example, the functions to be permanently de-activated may include executing a predefined software, such as a test, accessing a predefined circuit portion, accessing a memory portion, assigning a permission, disabling an interface, disabling an interrupt, disabling a change of data, and/or disabling a change of configuration settings.

For example, the functions to be permanently activated may include requesting an authentication, running a supervising process, for example a watchdog, executing a predefined software, for example a key generator, enabling an interface, enabling an interrupt, enabling a change of data, and enabling a change of configuration settings. Also, a recording of a level, e.g., a filling level, may be regarded as a kind of permanent activation. For example, a dropping level of a consumable in a container, e.g., ink in a printer cartridge, may be recorded by subsequently forming memory cells. Thereby, it may be ensured that the container may be emptied only once, instead of being refilled by third parties other than the distributor of the container/cartridge.

In general, the person skilled in the art will understand whether the function to be provided with the “fuse” depends on the formed memory cell state (e.g., essentially irreversible by on-board, e.g., on-chip, means) for an enabling of the function or a disabling of the function, and may choose accordingly whether the pattern to be matched is required for an enabling of the function or for a disabling of the function.

In various embodiments, the circuit may include a read unit, i.e., a read circuit. The read unit may be configured to read, e.g. essentially as known in the art, cell values, e.g. cell current values, cell resistance values, or the like, individually from each memory cell of the at least one memory cell. or measure a time duration for a voltage or current profile or progression. Also the gradient of an electrical parameter might be used in the determination of the cell value. The read unit may furthermore be configured to differentiate, e.g. using a threshold value, between the SET state and the RESET state. In various embodiments, the read unit may furthermore be able to differentiate between the RESET state and the unformed state.

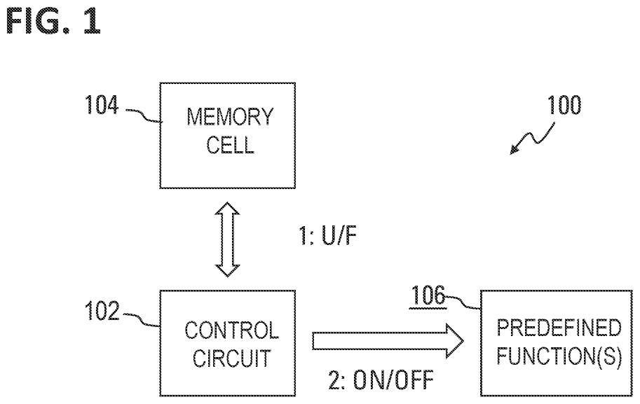

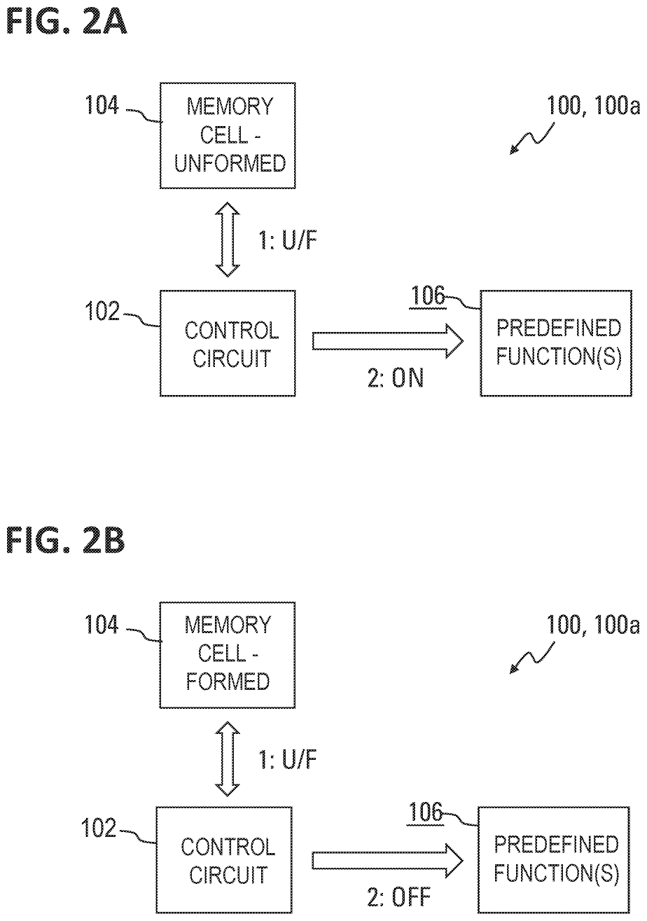

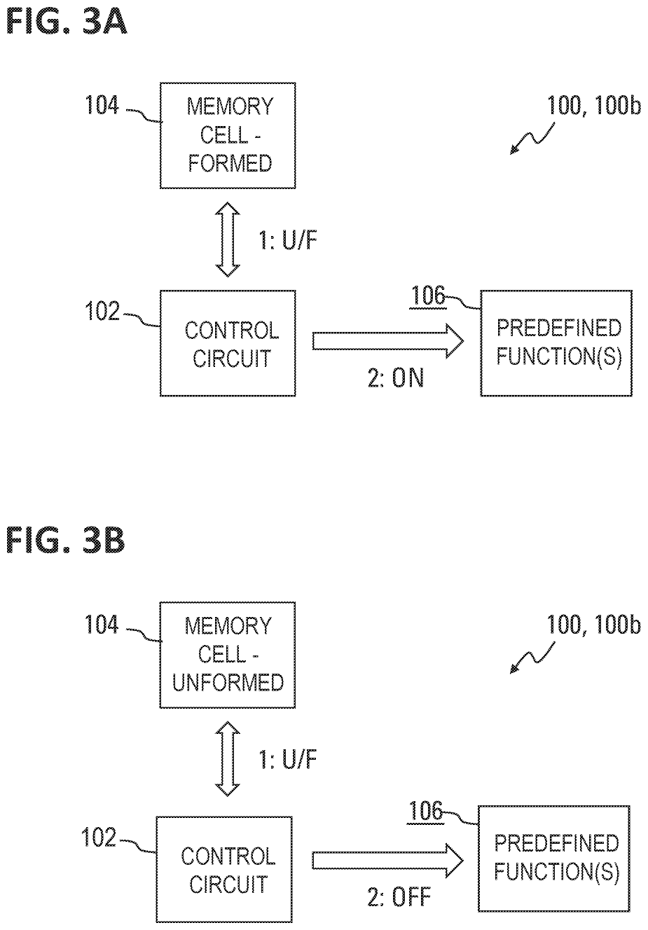

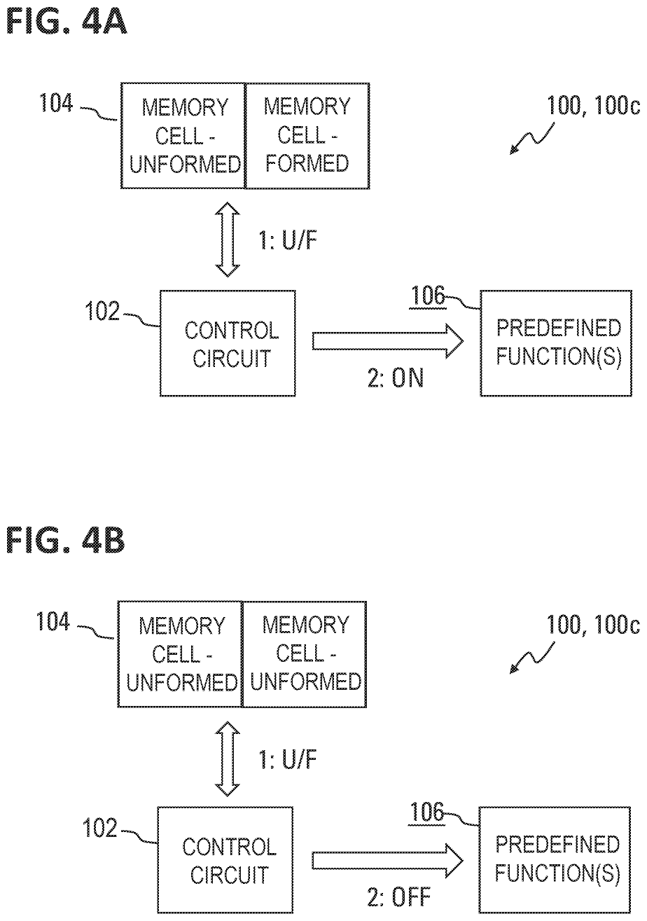

FIG. 1 schematically illustrates an electronic circuit 100 in accordance with various embodiments. FIG. 2A and 2B schematically illustrate two different states of an electronic circuit 100 in accordance with various embodiments, more particularly of an embodiment of an electronic circuit 100a. FIG. 3A and 3B schematically illustrate two different states of an electronic circuit 100 in accordance with various embodiments, more particularly of an embodiment of an electronic circuit 100b. FIG. 4A and 4B schematically illustrate two different states of an electronic circuit 100 in accordance with various embodiments, more particularly of an embodiment of an electronic circuit 100c.

The electronic circuit 100 may include at least one memory cell 104 and a control circuit 102 configured to determine a formation state of the at least one memory cell 104. This is indicated in FIG. 1 as: “1: U/F”, which is meant to visualize that the control circuit 102 determines whether the at least one memory cell 104 is formed (F) or unformed(U), wherein the formation states may he defined as specified above. For short, the unformed state may be an electrically isolated state, and the formed state may be a state into which an initially unformed memory cell 104 may be transformable (e.g., at least with on-board means, irreversibly), in which the formed memory cell 104 is repeatedly switchable between a state of low electrical resistivity and a state of high electrical resistivity.

In a case of the at least one memory cell 104 including a plurality of memory cells 104, the state of each memory cell 104 of the plurality of memory cells 104 mas be individually determined.

The control circuit 102 may further be configured to enable a predefined function 106 (more generally, a plurality of functions 106 may be enabled through a single determined formation state, but for ease of description, typically, only a single predefined function 106 is referred to) only if the determined formation state of the at least one memory cell 104 matches a predefined formation state pattern, and/or if a minimum number or fraction of the at least one memory cell 104 has a predefined formation state. Since both functionalities, a permanent activation and a permanent deactivation, may he enabled by a single one-way process (the forming process), FIG. 1 illustrates the determining of the formation state as “1: U/F”, and the formation state dependent activation as “2: ON/OFF”,

FIGS. 2A and 2B on the one hand, and FIGS. 3A and 3B, on the other hand, illustrate exemplary embodiments of functions 106 that may be permanently switched off (FIGS. 2A/2B) or permanently switched on (FIGS. 3A/3B) using a single memory cell 104.

In various embodiments, the single memory cell 104 may be used for enabling one or more functions 106, while disabling one or more different functions 106.

The exemplary embodiment shown in FIG. 2A and 2B indicates a case in which a function 106 may be permanently switched off. In other words, the function 106 may only be enabled (FIG. 2A; indicated by “2: ON”) while the memory cell 104 is in the unformed state U. Once the memory cell 104 has been permanently switched to the formed state F, for example by applying a comparatively high forming voltage, for example as described below, the control circuit 102 may be configured to, upon determining the formed state F, block an execution of the function 106, as indicated in FIG. 2B by “2: OFF”.

In other words, in the exemplary embodiment of FIGS. 2A and 2B, the predefined formation state pattern that leads to an enabling of the function may be the unformed state of the single memory cell 104. The alternative conditions referring to the minimum number or minimum percentage described above are more relevant for the case in which a plurality of memory cells 104 is used, but in the case of the single memory cell 104, this may be considered to correspond to a minimum number of “1” or a minimum percentage of “100%” in the unformed state.

The predefined function 106, in particular the predefined function 106 that is supposed to be permanently switched off, may for example include or consist of executing a predefined software (for example a test), accessing a predefined circuit portion, accessing a memory portion, assigning a permission, disabling an interface, disabling an interrupt, disabling a change of data, and/or disabling a change of configuration settings.

The exemplary embodiment shown in FIGS. 3A and 3B indicates a case in which a function 106 may be permanently switched on. In other words, the function 106 may only be enabled (FIG. 3A; indicated by “2: ON”) while the memory cell 104 is in the formed state F. In other words, once the memory cell 104 has been permanently switched to the formed state F, for example by applying a comparatively high forming voltage, for example as described above, the control circuit 102 may be configured to, upon determining the formed state F, allow an execution of the function 106. Before the memory cell 104 is switched to the formed state F, while it is in the unformed state U, as indicated in FIG. 3B, the control circuit 102 may he configured to block the function 106, as indicated by “2: OFF”.

In other words, in the exemplary embodiment of FIGS. 3A and 3B, the predefined formation state pattern that leads to an enabling of the function may be the formed state of the single memory cell 104. Similar to what was described above, this may be considered to correspond to a minimum number of “1” cell or a minimum percentage of “100%” in the formed state.

The predefined function 106, in particular the predefined function 106 that is supposed to be permanently switched on, may for example include or consist of requesting an authentication, running a supervising process, for example a watchdog, executing a predefined software, for example a key generator, enabling an interface, enabling an interrupt, enabling a change of data, and/or enabling a change of configuration settings.

In various embodiments, the control circuit 102 may be configured to determine the formation state of the at least one memory cell 104 by attempting to write to the at least one memory cell 104, e.g., to set the at least one memory cell 104 to the low resistivity state (the SET state) or to the high resistivity state (the RESET state) for determining the formation state (unformed U or formed F) of the at least one memory cell 104. The SET state may be preferred, since a successful writing may he more easily verified because of the large difference in electrical resistance between the unformed state and the SET state. In other words, if it is determined that the write process is successful, the respective memory cell 104 is determined to be formed F. If the write process fails, the respective memory cell 104 is determined to be unformed U.

As described above, the writing may succeed only in the case of the formed memory cell 104. A reason for this is that the low writing voltage may be sufficient for closing a small gap in an already established current path, but insufficient for creating such a current path.

For the writing, the electronic circuit 100 may include a write circuit (not shown) controlled by the control circuit 102 and configured to attempt to set the at least one memory cell 104 to the low resistivity state (or, optionally, to the high resistivity state) for determining the formation state of the at least one memory cell 104. Functionalities of the write circuit may essentially correspond to those of known write circuits.

The write circuit may be configured to write to each of the at least one memory cell 104 individually.

The write circuit may be configured to provide two different modes. In a forming mode, the write circuit, may be configured to provide a high voltage of 2.5V to 3.5V, also referred to as a forming voltage, to each of the memory cells which are to be formed, i.e. which are to be transferred from an electrically isolated state to an electrically conductive state, and to thereby form the respective memory cell 104. In a regular write mode, the write circuit may be configured to provide a lower voltage of 1.5V to 2.0V, also referred to as a programming voltage, of a suitable polarity, to each of the memory cells 104, e.g. the formed memory cells 104, which are to be analyzed regarding their formation state.

In various embodiments, it may be useful to know whether an attempt has been made to simulate an unformed memory cell 104 by setting the at least one memory cell 104 to the (high resistivity) RESET state. In at least some cases, this may be indicative of a malicious attack or of a degenerative process that may have caused a malfunctioning of the at least one memory cell 104.

Thus, in various embodiments, the control circuit 102 may be configured to raise an alarm if the at least one memory cell 104 is determined to be in the RESET state.

For this (and/or optionally other purposes), the electronic circuit 100 may include a read circuit (not shown) controlled by the control circuit 102 and configured to read the at least one memory cell 104. The read circuit may be similar or identical to read circuits as known in the art. For example, a resistance, current or voltage of the at least one memory cell 104 may be determined by a comparison to a threshold value.

To determine the RESET state of the memory cell 104 and to clearly distinguish it from the unformed state, the control circuit 102 may be configured to first read the at least one memory cell 104 using the read circuit, and to subsequently determine the formation state of the at least one memory cell, for example by using the write circuit to attempt to set the at least one memory cell 104 to the SET state.

The control circuit 102 may be configured to issue an alarm if the at least one memory cell 104 is read to be in the high resistivity state (the RESET state), and the determined formation state is the formed state F.

In various embodiments, the read circuit may be able to differentiate between the unformed state and the high resistivity RESET state. In such a case, the write attempt for determining the formation state of the at least one memory cell 104 may be obsolete.

FIG. 4A and 4B illustrate an exemplary embodiment of an electronic circuit 100, 100c that uses a plurality (in this case two) of memory cells 104 for creating a switch that allows to permanently switch the function 106 on or off. Apart from the use of the plurality of memory cells 104, the specification above may apply also to the embodiments of FIG. 4A and FIG. 4B.

FIG. 4A and 413 may he illustrative for various ways to use the plurality of memory cells:

In an exemplary embodiment, the predefined pattern of formation states that needs to be matched for enabling the function 106 may be “U F”. Thus, the function 106 is enabled in FIG. 4A (where the memory cells 104 have formation states “U F”), and disabled in FIG. 4B (where the memory cells 104 have formation states “U U”).

This allows, for example, a creation of a temporarily available function. After formation, the plurality of memory cells 104 may both/all be in the unformed state “U U”, and thus the function may be switched off, as shown in 4B. For enabling the function, the memory cell 104 shown on the right of the pair of memory cells 104 in FIG. 4A may be formed (state F). As shown in FIG. 4A, the function 106 may be enabled (and possibly be compulsory while it is available). The function 106 may be deactivated again by forming also the other (left) memory cell 104.

In another exemplary embodiment, at least one of the memory cells 104 may he required to be in the formed state F for activating the function 106. Thus, the function 106 is enabled in FIG. 4A (where the memory cells 104 have formation states “U F”, in other words, one of the memory cells 104 is in the formed state F) and disabled in FIG. 4B (where both memory cells 104 have formation states “U U” and thus none is in the formed state).

This gives the possibility to permanently activate the function 106 without having to know which of the memory cells 104 need to be formed.

This may apply in a similar way if an amount memory cells 104 that are to be in a specific state is specified as a fraction of the total number of memory cells 104 (in this case, for example 50%). This may for example be useful for level-type permission, for example a higher fraction of memory cells 104 may correspond to a higher level of permission(e.g read access vs. write access, and the like).

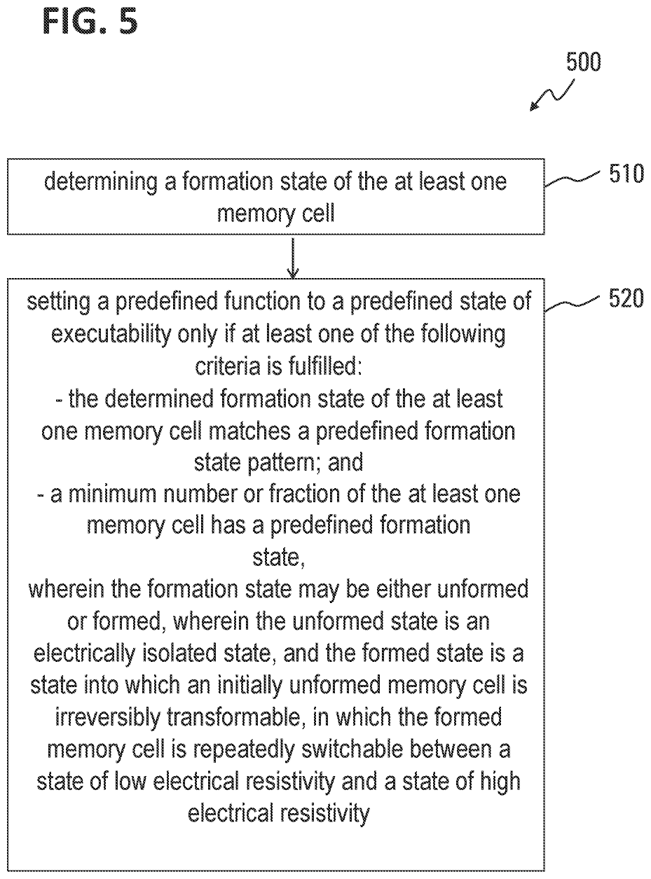

FIG. 5 shows a process flow500 of a method of operating an electronic circuit accordance with various embodiments.

The electronic circuit may include at least one memory cell.

The method may include determining a formation state of the at least one memory cell (510) and setting a predefined function to a predefined state of executability only if at least one of the following criteria is fulfilled: the determined formation state(s) of the at least one memory cells) matches a predefined formation state pattern, and a minimum number or fraction of the at least one memory cell has a predefined formation state, wherein the formation state may be either unformed or formed, wherein the unformed state is an electrically isolated state, and the formed state is a state into which an initially unformed memory cell is (e.g., by on-board means irreversibly) transformable, in which the formed memory cell is repeatedly switchable between a state of low electrical resistivity and a state of high electrical resistivity (520).

Various examples be illustrated in the following:

Example 1 is an electronic circuit. The electronic circuit may include one or more memory cells and a control circuit configured to carry out a method like any of those described above. For example, the control circuit may be configured determine a formation state for each of at least one of the one or more memory cells and set a predefined function to a predefined state of executability (e.g., either enabled or disabled) based on the determined formation state(s). In some embodiments, the control circuity may be configured to set the predefined function to the predefined state of executability based on the determined formation state for only a single cell. In other embodiments, the control circuity may be configured to set the predefined function to the predefined state of executability based on the determined formation states for two or more memory cells, e.g., if at least one of the following criteria is fulfilled: the determined formation state of the two or more memory cells match a predefined formation state pattern, and a minimum number or fraction of the two or more memory cells have a predefined formation state. As discussed above, the formation state may be either unformed or formed, where the unformed state is an electrically isolated state and the formed state is a state into which an initially unformed memory cell is transformable and in which the formed memory cell is repeatedly switchable between a state of low electrical resistivity and a state of high electrical resistivity.

In Example 2, the subject-matter of Example 1 may optionally include that the predefined formation state pattern or the minimum number of memory cells having the predefined formation state includes at least one unformed memory cell, and the predefined state of executability is enabled, thereby establishing a mechanism to permanently deactivate the predefined function.

In Example 3, the subject-matter of Example 1 or 2 may optionally include that the predefined function includes at least one of a group of functions, the group including executing a predefined software, for example a test, accessing a predefined circuit portion, accessing a memory portion, assigning a permission, disabling an interface, disabling an interrupt, disabling a change of data, and disabling a change of configuration settings.

In Example 4, the subject-matter of Example 1 may optionally include that the predefined formation state pattern or the minimum number of memory cells having the predefined formation state includes at least one formed memory cell, and the predefined state of executability is enabled, thereby establishing a mechanism to permanently activate the predefined function.

In Example 5, the subject-matter of Example 1 or 4 may optionally include that the predefined function includes at least one of a group of functions, the group including requesting an authentication, running a supervising process, for example a watchdog, executing a predefined software, for example a key generator, enabling an interface, enabling an interrupt, enabling a change of data, and enabling a change of configuration settings.

In Example 6, the subject matter of any of Examples 1 to 5 may optionally further include a write circuit controlled by the control circuit and configured to attempt to set the at least one memory cell to the low resistivity state or to the high resistivity state for determining the formation state of the at least one memory cell

In Example 7, the subject matter of any of Examples 1 to 6 may optionally further include a read circuit controlled by the control circuit and configured to read one or more of the memory cells.

In Example 8, the subject-matter of Example 7 may optionally include that the control circuit is configured to first read a given memory cell, and to subsequently determine the formation state of the memory cell.

In Example 9, the subject-matter of Example 8 may optionally include that the control circuit is configured to issue an alarm if at least one memory cell is read to be in the high resistivity state, and the determined formation state is the formed state.

Example 10 is a method of operating an electronic circuit that includes at least one memory cell. The method may include determining a formation state of the at least one memory cell and setting a predefined function to a predefined state of executability (e.g., either enabled or disabled) only if at least one of the following criteria is fulfilled: the determined formation state of the at least one memory cell:matches a predefined formation state pattern, and a minimum number or fraction of the at least one memory cell has a predefined formation state, wherein the formation state may be either unformed or formed, wherein the unformed state is an electrically isolated state, and the formed state is a state into which an initially unformed memory cell is transformable, in which the formed memory cell is repeatedly switchable between a state of low electrical resistivity and a state of high electrical resistivity.

In Example 11, the subject-matter of Example 10 may optionally include that the predefined formation state pattern or the minimum number of memory cells having the predefined formation state includes at least one unformed memory cell, and the predefined state of executability is enabled, thereby establishing a mechanism to permanently deactivate the predefined function.

In Example 12, the subject-matter of Example 10 or 11 may optionally include that the predefined function includes at least one of a group of functions, the group including executing a predefined software, for example a test, accessing a predefined circuit portion, accessing a memory portion, assigning a permission, disabling an interface, disabling an interrupt, disabling a change of data, and disabling a change of configuration settings.

In Example 13, the subject-matter of Example 10 may optionally include that the predefined formation state pattern or the minimum number of memory cells having the predefined formation state includes at least one formed memory cell, and the predefined state of executability is enabled, thereby establishing a mechanism to permanently activate the predefined function.

In Example 14, the subject-matter of Example 10 or 13 may optionally include that the predefined function includes at least one of a group of functions, the group including requesting an authentication, running a supervising process, for example a watchdog, executing a predefined software, for example a key generator, enabling an interface, enabling an interrupt, enabling a change of data, and enabling a change of configuration settings.

In Example 15, the subject matter of any of Examples 10 to 14 may optionally further include attempting to set the at least one memory cell to the low resistivity state or the high resistivity state for determining the formation state of the at least one memory cell.

In Example 16, the subject matter of any of Examples 10 to 15 may optionally further include reading the at least one memory cell.

In Example 17, the subject-matter of Example 16 may optionally include that the determining the formation state of the at least one memory cell is performed after the reading of the at least one memory cell.

In Example 18, the subject-matter of Example 17 may optionally further include issuing an alarm if the at least one memory cell is read to be in the high resistivity state, and the determined formation state is the formed state.

In Example 19, the subject matter of any of Examples 1 to 4 may optionally include that predefined function includes at least one of a group of functions, the group including executing a predefined software, for example a test, accessing a predefined circuit portion, accessing a memory portion, assigning a permission, disabling an interface, disabling an interrupt, disabling a change of data, disabling a change of configuration settings, requesting an authentication, running a supervising process, for example a watchdog, executing a predefined software, for example a key generator, enabling an interface, enabling an interrupt, enabling a change of data, enabling a change of configuration settings, assigning a life cycle state, locking a predefined feature or a higher-level system that the electronic circuit is part of, defining access rights, defining a value or a key, setting a processing speed, and identifying a state (for example a test state).

While the invention has been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

What is claimed is:

1. An electronic circuit, comprising:
one or more memory cells; and
a control circuit configured to:
determine a formation state for each of at least one of the one or more memory cells; and
set a predefined function to a predefined state of executability based on the determined formation state(s),
wherein the formation state for each of the at least one of the one or more memory cells is either unformed or formed, wherein the unformed state is an electrically isolated state, and the formed state is a state into which an initially unformed memory cell is transformable and in which the formed memory cell is repeatedly switchable between a state of low electrical resistivity and a state of high electrical resistivity.

2. The electronic circuit of claim 1, wherein the control circuit is configured to set the predefined function to the predefined state of executability based on the determined formation state for a single one of the one or more memory cells.

3. The electronic circuit of claim 1, wherein the control circuit is configured to determine the formation state for each of two or more memory cells and to set the predefined function to the predefined state of executability in response to determining that the determined formation states match a predefined formation state pattern.

4. The electronic circuit of claim 1, wherein the control circuit is configured to determine the formation state for each of two or more memory cells and to set the predefined function to the predefined state of executability in response to determining that a minimum number or fraction of the two or more memory cells have a predefined one of the formed and unformed states.

5. The electronic circuit of claim 1, wherein the predefined state of executability is either enabled or disabled.

6. The electronic circuit of claim 1, wherein the predefined function comprises at least one of a group of functions, the group comprising:
executing a predefined software;
accessing a predefined circuit portion;
accessing a memory portion;
assigning a permission;
disabling an interface;
disabling an interrupt;
disabling a change of data,
disabling a change of configuration settings;
requesting an authentication;
running a supervising process;
executing a key generator;
enabling an interface;
enabling an interrupt;
enabling a change of data,
enabling a change of configuration settings;
assigning a life cycle state;
locking a predefined feature or a higher-level system that the electronic circuit is part of;
defining access rights;
defining a value or a key;
recording a level;
setting a processing speed; and
identifying a state.

7. The electronic circuit of claim 1, further comprising:
a write circuit controlled by the control circuit and configured to attempt to set each of the at least one of the one or more memory cells to the low resistivity state or to the high resistivity state for determining the formation state of respective memory cell.

8. The electronic circuit of claim 1, further comprising:
a read circuit controlled by the control circuit and configured to read each of the at least one of the one or more memory cells.

9. The electronic circuit of claim 8, wherein the control circuit is configured to, for each of the at least one of the one or more memory cells, first read the respective memory cell and to subsequently determine the formation state of the respective memory cell.

10. The electronic circuit of claim 9, wherein e control circuit is configured to issue an alarm if at least one memory cell is read to be in the high resistivity state and the respective determined formation state is the formed state.

11. A method of operating an electronic circuit comprising one or more memory cells, the method comprising:
determining a formation state for each of at least one of the one or more memory cells; and
setting a predefined function to a predefined state of executability based on the determined formation state(s),
wherein the formation state for each of the at least one of the one or more memory cells is either unformed or formed, wherein the unformed state is an electrically isolated state, and the formed state is a state into which an initially unformed memory cell is transformable and in which the formed memory cell is repeatedly switchable between a state of low electrical resistivity and a state of high electrical resistivity.

12. The method of claim 11, wherein the method comprises setting the predefined function to the predefined state of executability based on the determined formation state for a single one of the one or more memory cells.

13. The method of claim 11, wherein the method comprises determining the formation state for each of two or more memory cells and setting the predefined function to the predefined state of executability in response to determining that the determined formation states match a predefined formation state pattern.

14. The method of claim 11, wherein the method comprises determining the formation state for each of two or more memory cells and setting the predefined function to the predefined state of executability in response to determining that a minimum number or fraction of the two or more memory cells have a predefined one of the formed and unformed states.

15. The method of claim 11, wherein the predefined state of executability is either enabled or disabled.

16. The method of claim 11, wherein the predefined function comprises at least one of a group of functions, the group comprising:
executing a predefined software;
accessing a predefined circuit portion;
accessing a memory portion;
assigning a permission;
disabling an interface;
disabling an interrupt
disabling a change of data,
disabling a change of configuration settings;
requesting an authentication;
running a supervising process;
executing a key generator;
enabling an interface;
enabling an interrupt;
enabling a change of data,
enabling a change of configuration settings;
assigning a life cycle state;
locking a predefined feature or a higher-level system that the electronic circuit is part of;
defining access rights;
defining a value or a key;
recording a level;
setting a processing speed; and
identifying a state.

17. The method of claim 11, further comprising:
attempting to set each of the at least one of the one or more memory cells to the low resistivity state or the high resistivity state for determining the formation state of the respective memory cell.

18. The method of claim 11, further comprising:
reading each of the at least one of the one or more memory cells.

19. The method of claim 18, wherein, for each of the at least one of the one or more memory cells, the determining the formation state of the respective memory cell is performed after the reading of the respective memory cell.

20. The method of claim 19, further comprising issuing an alarm at least one memory cell is read to be in the high resistivity state and the respective determined formation state is the formed state.
